(19) United States
(12) Patent Application Publication
(10) Pub. No.: US 2022/0185620 A1
(43) Pub. Date: Jun. 16, 2022

(54) WINCH COMPRISING A WINDING DEVICE

(71) Applicant: Movecat GmbH, Nufringen (DE)

(72) Inventor: Andrew Abele, Nufringen (DE)

(73) Assignee: Movecat GmbH, Nufringen (DE)

(21) Appl. No.: 17/598,677

(22) PCT Filed: Mar. 23, 2020
(86) PCT No.: PCT/EP2020/058004

§ 371 Date: Sep. 27, 2021

(30) Foreign Application Priority Data
Mar. 27, 2019 (DE) 10 2019 107 937.3

(51) Int. Cl. B65H 75/44; B66D 1/38; B66D 3/20; B66D 3/24; B66D 3/26

(52) U.S. Cl. CPC B65H 75/4407; B65H 75/4415; B65H 75/446; B65H 75/4484; B65H 2701/35; B66D 3/20; B66D 3/24; B66D 3/26; B65H 2701/34; B66D 1/38

(57) ABSTRACT

The invention relates to a winch comprising a winding device, which is simply constructed and works very reliably, regardless of the position and orientation of the winch.

### BACKGROUND

The invention relates to a winch comprising a drum, a suspension means, a winding device and a frame, the frame having a mounting for the drum and a linear guide for the winding device.

Winches having a cylindrical drum on which a suspension means can be wound and unwound are known in many ways. They are used in a wide variety of fields of use, from stage technology to recovery winches or crane construction. The term “suspension means” includes both ropes, in particular steel ropes, and electrical cables that transmit electrical currents or signals by means of various wires in the cable. In many cases, a tension strand is also incorporated into such a cable as mechanical strain relief for the wires of the cable. These are also “suspension means” within the meaning of the invention.

Ropes and electrical cables usually have a circular cross section, and it is therefore advantageous if a helical groove is provided on the cylindrical outer surface of the drum. This helical groove is matched to the diameter of the suspension means to be wound in terms of pitch and cross-sectional contour. The cross-sectional contour is designed to be complementary to the cross section of the suspension means. The pitch of the groove is at least as large as the diameter of the suspension means.

This way of winding a cable or a suspension means on a drum is very advantageous because a very large contact surface is created between the suspension means and the groove during winding. As a result of winding or unwinding the suspension means on the drum, the suspension means is not twisted, kinked or damaged in any other way.

So-called winding devices are known in order to ensure that the suspension means is placed in the groove of the drum, even under the most adverse conditions. These winding devices are nothing more than a guide for the suspension means that moves in parallel with the axis of rotation of the drum and in dependence on the rotational movements of the drum. When the drum has carried out one revolution, the winding device moves by the amount of the pitch of the groove on the drum.

In order to produce the desired coupling between the winding device and the rotational speed of the drum, trapezoidal and ball lead screws are known which are arranged parallel to the drum and which are coupled to the drum via a toothed belt or spur gear toothing. A nut, which is coupled to part of the winding device, is arranged on the lead screw. In this way, the coupling between the winding device and the drum is ensured. This embodiment works, but is relatively complex to manufacture and requires an adaptation of the screw drive for each diameter of the suspension means. It also requires a coupling between the drum and the threaded rod. This causes relatively high manufacturing costs and makes this embodiment fault-prone.

### SUMMARY OF THE INVENTION

The problem addressed by the invention is that of providing a winch which works very reliably and with little noise. The latter aspect is particularly important for uses in stage technology. Any operating noise, squeaking or rattling is not acceptable in this profession. In addition, the winch should be easily adaptable to different diameters of the suspension means.

This problem is solved according to the invention by a winch comprising a drum, a suspension means, a winding device and a frame, the frame having a mounting for the drum and a linear guide for the winding device, the drum having a helical groove and the winding device having a coupling roller, and the coupling roller having at least one collar which engages in the helical groove of the drum. In a preferred embodiment, the collar therefore has a cross section that is complementary to the profile of the helical groove.

According to the invention, the winding device therefore has a coupling roller having a collar. This collar engages in the groove of the drum. The axes of rotation of the drum and the coupling roller are usually parallel to one another. It is also possible, however, to position the axis of rotation of the coupling roller slightly obliquely with respect to the axis of rotation of the drum. The angle between the axes of rotation of the drum and the coupling roller corresponds to the pitch angle of the helical groove of the drum. This results in a particularly low-friction and low-noise running of the coupling roller.

Alternatively or in addition, it is also possible to design the collar of the coupling roller to be somewhat narrower in cross section than the profile of the groove. Then, even if the axes of rotation of the coupling roller and drum extend in parallel with one another, the collar can engage in the helical groove of the drum with zero backlash and with little friction.

The frame of the winch according to the invention preferably has two lateral walls. These lateral walls can be made of sheet metal, for example by CNC laser cutting. A mounting for the drum is formed on the lateral walls. The mounting can be provided by sliding and/or roller bearings. The drum is preferably rotatably mounted at both ends.

The distance between the lateral walls of the frame is ideally provided by cross members. These cross members can be round bars, preferably made of metal, which each have an internal thread at the ends thereof and are screwed to the lateral walls of the frame. At least one of the cross members is also designed as a linear guide for the winding device. In a further improved embodiment, two or more cross members extending in parallel with one another are designed as a linear guide for the winding device.

In this case, the frame or housing of the winding device has guide bushes on both sides, preferably made of a friction-optimized plastics material, such as PTFE, or metal, such as brass. These bushes slide on the cross members and thus create a linear guide.

The winding device according to the invention comprises a guide roller for the suspension means, the guide roller having a circumferential notch, the notch bottom of which is at least as wide as the diameter of the suspension means. The suspension means then rests on the bottom of the notch and is optimally guided by the guide roller and cannot deflect laterally. Because the winding device according to the invention is coupled to the drum via the coupling roller, the winding device moves along together with the drum. This movement of the winding device is coupled to the rotational movements of the drum via the coupling roller. This ensures that the suspension means is always placed centrally, i.e. without offset, into the groove of the drum from the guide roller when the suspension means is wound onto the drum. Even when the suspension means is unwound from the roller, it is ensured that the suspension means runs straight off the drum without any offset or mechanical loads. By means of the guide roller, the drum is also relieved of laterally acting forces which can be introduced into the winch by the suspension means.

In a further advantageous embodiment of the invention, the winding device has a hold-down roller. This hold-down roller engages in the notch of the guide roller. Sufficient space remains between the outer diameter of the hold-down roller and the bottom of the notch in the guide roller for the suspension means which is to be wound on. The guide roller and hold-down roller, which engage in one another, prevent the suspension means from “jumping out” of the guide roller in an undesired manner.

The winding device according to the invention ensures an ideal orientation of the suspension means relative to the groove of the drum, even under adverse operating conditions. This ensures a very precise winding of the suspension means onto the drum that is gentle on the suspension means. This applies regardless of the working position and orientation of the winch.

In an advantageous development, the coupling roller has two collars. The two collars engage in the groove of the drum. The axial distance between the collars is as great as the pitch of the helical groove. It can also be an integral multiple of the pitch of the helical groove. This further improves the coupling between the winding device and the drum.

It is also possible for the two collars of the coupling roller to be formed at the two ends of the coupling roller and for the suspension means, which are to be wound on or unwound, to extend through the two collars. A collar cannot then engage in the groove of the drum, but rolls on a projection between two adjacent turns of the groove.

In a simplified embodiment, the functions of the coupling roller and the guide roller are integrated in one roller. This means that the coupling roller has a notch which is axially spaced apart from the at least one collar, in which notch the suspension means is guided. This results in a more compact and cost-effective construction.

The suspension means can be an electrical cable, in particular comprising a tension strand, or a rope. Steel cables or ropes made of aramid or other fibers can be used.

In an advantageous development, the winch has a rotational angle sensor coupled to the drum and/or limit switches. The limit switches ensure that the suspension means is not unwound too far from the drum. This could specifically result in the weight forces acting on the suspension means overloading the fastening of the suspension means to the drum. The angle of wrap of the suspension means around the drum is usually no less than 360°. It is preferably 720° or greater. The tensile forces to be introduced into the drum by the suspension means are then transmitted via the frictional connection between the wound suspension means and the drum, and not via a mechanical clamping piece with which the suspension means is usually mechanically connected in the interior of the drum. The mechanical clamping piece is helpful when assembling the winch and is a redundant securing means for the suspension means when the winch is in operation.

A limit switch is also required on the side of the other end position, i.e. when the drum is full. This should ensure that the end of the suspension means is not drawn into the winch. In particular, if a hook or a load, such as a lamp, is attached to the end of the suspension means, drawing this end too far into the winch would lead to damage to the winch and/or the hook/load.

The design details of the transmission of electrical power and/or electrical signals from the frame of the winch to the drum or to the electrical cable fastened to the drum (for example via slip ring contacts) are not the subject of the invention; they are known to a person skilled in the art and are therefore not explained.

Further advantages and advantageous embodiments of the invention can be found in the following drawings, the description thereof and the claims. All of the features disclosed in the drawings, the description thereof and the claims can be essential to the invention both individually and in any combination with one another.

### BRIEF DESCRIPTION OF THE DRAWINGS

In the drawings:

FIG. 1 is an isometric drawing of a winch according to the invention from the drive side;

FIG. 2 is a second isometric drawing of the winch according to the invention;

FIG. 3 is a side view of the winch with the drive;

FIG. 4 shows the winch according to the invention with a removed lateral wall;

FIG. 5 is an isometric view of the winding device according to the invention;

FIG. 6 to 8 are further detailed views of the winding device according to the invention;

FIG. 9 is a view from the front of the drum, the linear guide and the winding device;

FIG. 10 shows a pressing roller for the suspension means in the groove of the drum; and

FIGS. 11 and 12 are exploded views of the winch according to the invention.

### DESCRIPTION OF THE EMBODIMENT

The winch shown in the drawings relates to an embodiment in different views. In some cases, not all winch components are shown in order to improve clarity.

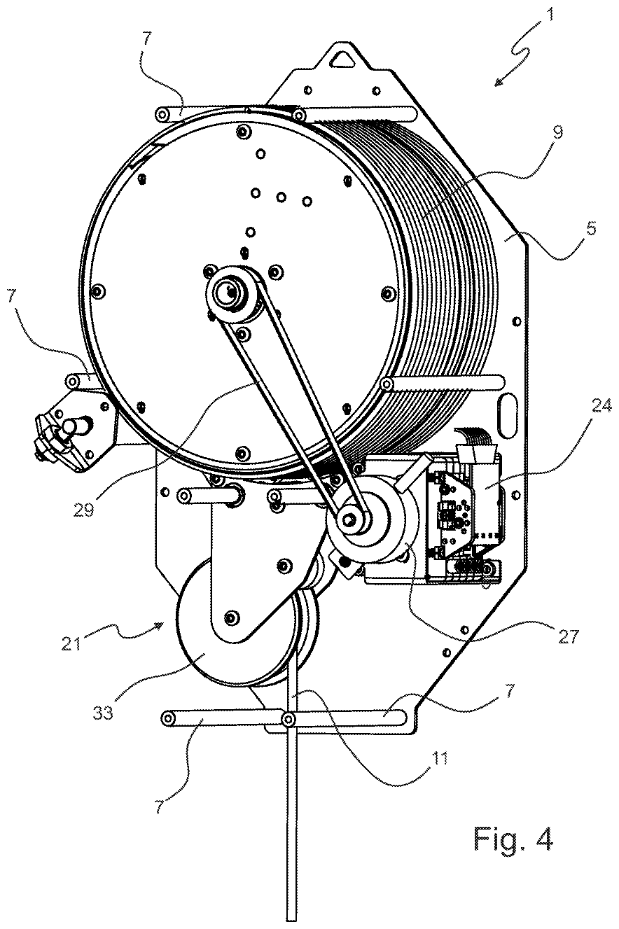

For example, one of the two lateral walls is not shown in FIG. 4, such that the drum, its mounting, and a rotational angle sensor and its coupling to the drum via a toothed belt can be clearly seen.

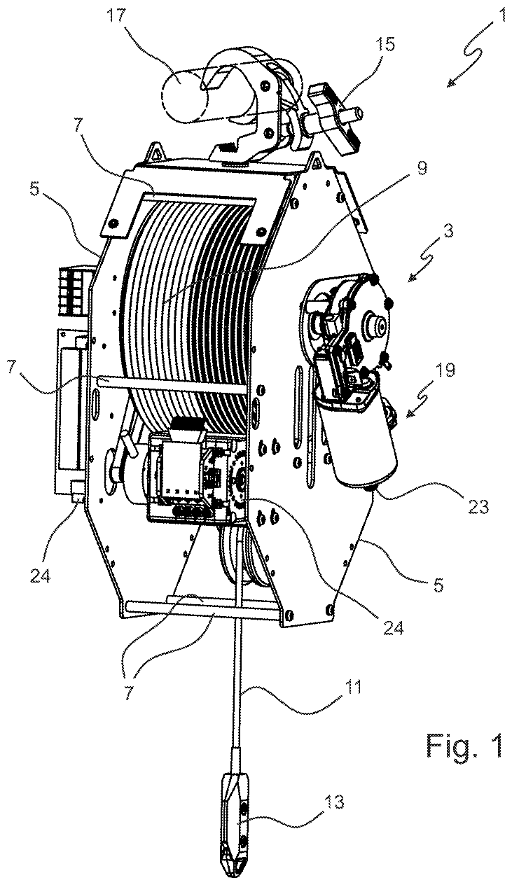

The same reference signs are used for the same components. The structural design of the winch according to the invention, and in particular of the winding device thereof, can be clearly seen from looking at FIG. 1 to 9 together.

In FIG. 1, a winch 1 according to the invention is shown in isometric drawing. The winch 1 according to the invention comprises a frame 3 which consists of lateral walls 5 and a plurality of cross members 7. The cross members 7 are simultaneously used as spacers for the lateral walls 5. One or more of the cross members can also form the linear guide for a winding device according to the invention (not visible in FIG. 1). In this embodiment, the cross members 7 are rods made of round material which have an internal thread at the ends thereof. Through-openings are provided in the lateral walls 5 at the corresponding points. Screws are screwed into the internal threads of the cross members through these through-openings. In this way, the cross members 7 and the lateral walls 5 are braced to form a stable frame 3.

In FIG. 1, not all of the cross members 7 are provided with reference signs. A drum 9 is rotatably mounted between the lateral walls 5. In FIG. 1, about half of the drum 9 is occupied by a suspension means 11. In FIG. 1, the suspension means 11 is wound onto the left-hand half of the drum 9. The right-hand half of the drum 9 is shown without suspension means. The suspension means 11 can be an electrical cable which transmits electrical power and signals to a load which can be attached to a lower end of the suspension means 11. No load is shown in FIG. 1. However, a lifting eye 13 to which the load can be attached is shown.

A clamp 15 can be seen at the upper end of the frame 3. By means of this clamp 15, the winch according to the invention can be clamped to a support tube 17 (not part of the winch). Of course, the winch 1 can also be fastened at a fastening point in other ways.

A drive 19 is shown on the right-hand side in FIG. 1. Said drive comprises an electric motor and a reduction gear, which can be designed as a self-locking worm gear. A first rotational angle sensor 23 can be integrated into the drive 19, which is designed as a geared motor in this embodiment. A limit switch 24 can be attached to one or both lateral walls 5. The limit switch(es) 24 prevent the suspension means from being unwound too far from the drum 9 or from being wound too far onto the drum 9.

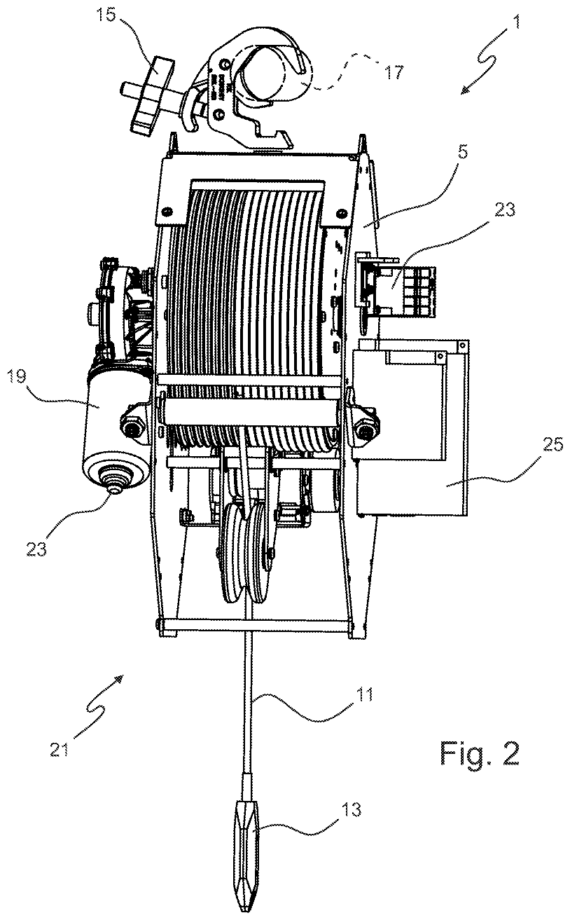

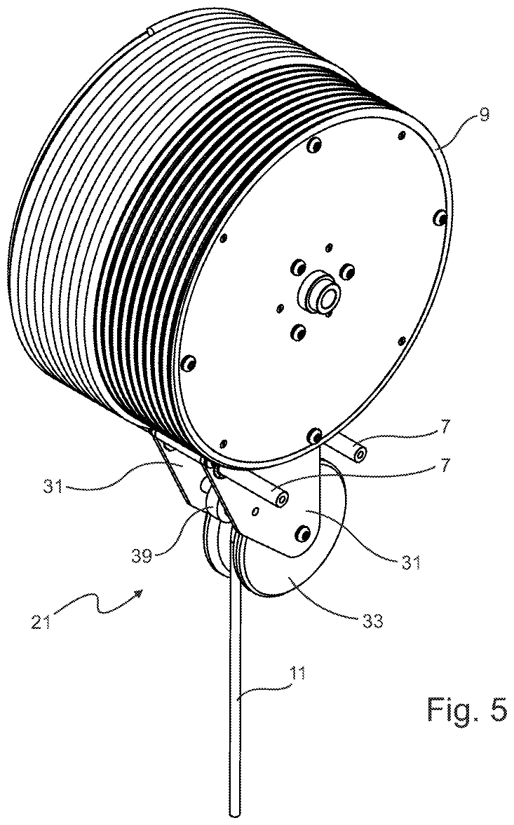

In FIG. 2, the winch 1 is shown in a slightly different perspective. The drive 19 can be seen on the left-hand side of the frame 3 in this view. A winding device 21 according to the invention can be seen in this view. The details of this winding device 21 are explained in detail in FIG. 5 to 10. A control device 25 is fastened to the side of the winch 1 that is opposite the drive 19.

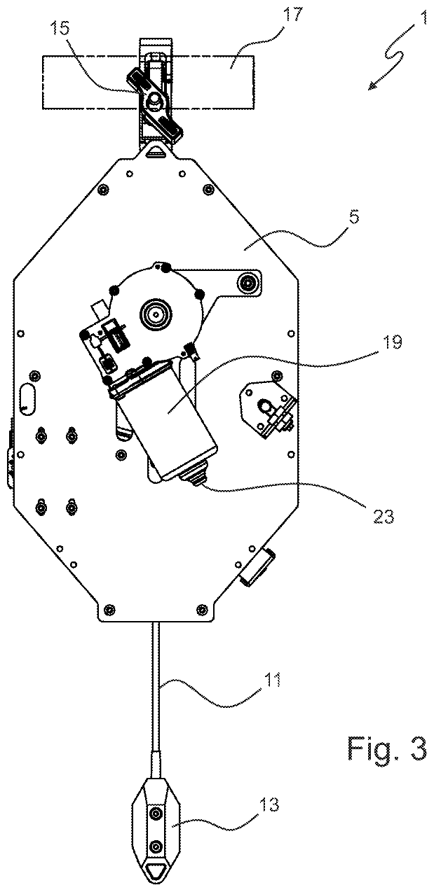

FIG. 3 shows a side view of the winch 1 with the drive 19.

In FIG. 4, the winch according to the invention is shown partially “cut open.” One lateral wall 5 and the drive 10 have thus been removed.

In this view, the cross members 7 can be seen clearly. The screws, which are screwed into the internal thread on the end face of the cross members 7 in order to connect the lateral wall 5 (not shown) to the cross members 7, can also be seen clearly.

A further rotational angle sensor 27 can be seen in this view. This further rotational angle sensor 27 is coupled to the drum 7 via a toothed belt drive 29. As a result, every rotational movement of the drum 7 is redundantly detected by the first rotational angle sensor 23 and the second rotational angle sensor 27. The function of a limit switch can also be implemented from the signals from these sensors 23 and 27. This means that the drive 19 is switched off when a first and a second end position of the drum are reached. This effectively prevents the suspension means 11 from being unwound too far from the drum 7 or the suspension means 11 being wound too far onto the drum. This would cause the lifting eye 13 (see FIG. 1) to crash into the frame 3 or the winding device 21. This has to be reliably prevented. The limit switches are used for this purpose.

Limit switches or buttons 24 can also be arranged on the lateral walls 5 and respond when the winding device comes into the vicinity of one of the lateral walls 5. A limit switch or button 24 which prevents the suspension means 11 from being wound too far onto or unwound too far from the drum 9 is visible in FIG. 4. When the limit switch 24 is triggered, the drive 19 is stopped.

In FIG. 1, the limit switch or button 24 is then arranged on the left-hand lateral wall 5, which prevents the suspension means 11 from being unwound too far. In FIG. 1, the limit switch or button is then arranged on the right-hand lateral wall 5, which prevents the suspension means 11 from being wound on too far and the lifting eye 13 from being drawn in as a result.

The drum 9, the suspension means 11 and two cross members 7 which support the winding device 21 are shown in FIG. 5. The two lateral walls 31 of the winding device 21 can be seen clearly in FIG. 5. The winding device 21 is guided on two cross members 7. The winding device 21 comprises two lateral walls 31, between which various spacers are arranged. These spacers cannot be clearly seen in FIG. 5. They are also used as bearing pins for the various rollers of the winding device. Furthermore, a guide roller 33 can be seen in FIG. 5. The suspension means is guided out of the winch or drawn in via the guide roller 33.

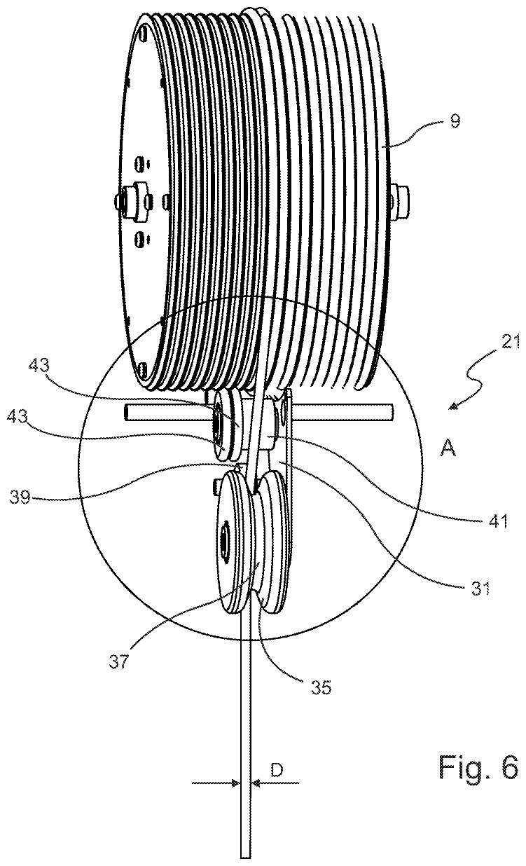

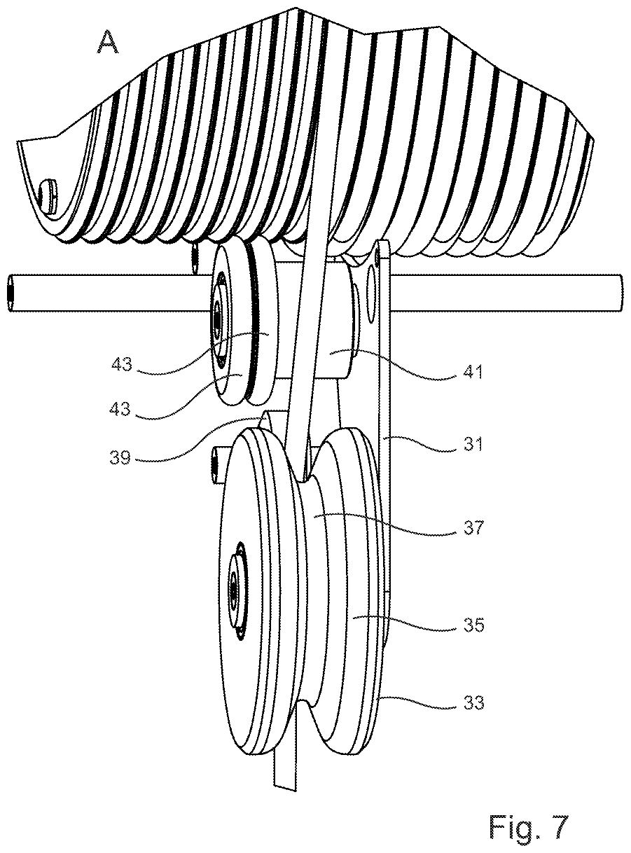

The guide roller 33 and the design thereof can be seen clearly in FIGS. 6 and 7. As can be seen from FIGS. 6 and 7, there is a circumferential notch 35 in the guide roller 33. The notch 35 is used to guide the suspension means. A notch bottom 37 is adapted to the diameter D of the suspension means with regard to the width and ideally also with regard to the profile thereof.

In the embodiment shown, the suspension means is a cable having a circular cross section and the diameter D. As a result, the notch bottom 37 is designed as a radius, the radius being approximately 0.5 times the diameter D.

The notch 35 is much deeper than the diameter D of the suspension means 11, such that the suspension means is laterally guided by the lateral walls of the notch 35. This already effectively prevents the suspension means 11 from jumping out of the notch 35.

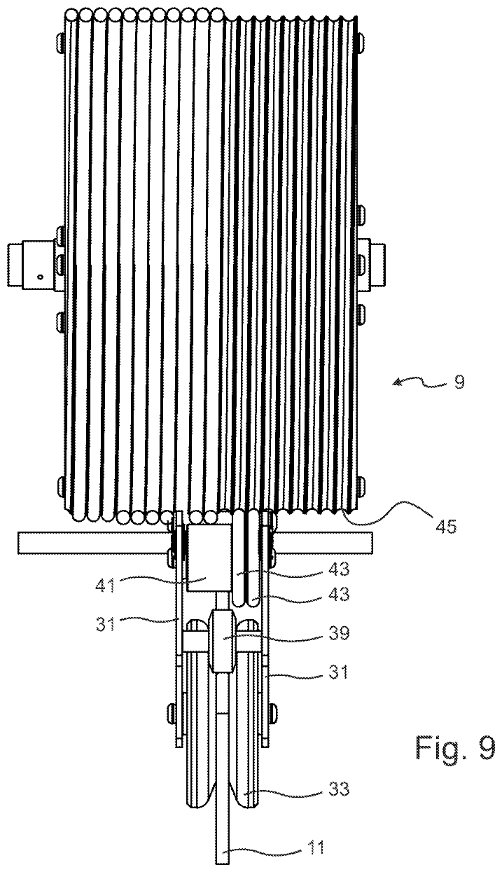

In addition, a further roller, specifically the hold-down roller 39, can be integrated into the winding device 21 in order to prevent the suspension means 11 from jumping out of the notch 35 even more effectively. The hold-down roller 39 is arranged in such a way that the collar thereof engages in the notch 35, such that the suspension means 11 rests on the notch bottom 37 on the inside in the radial direction and is guided radially on the outside by the collar of the hold-down roller 39. The suspension means is held laterally by the flanks of the notch 35. The shape of the hold-down roller 39 can be seen in FIG. 9. Said hold-down roller has two lateral bevels, the angle of which corresponds to the flank angle of the notch 35.

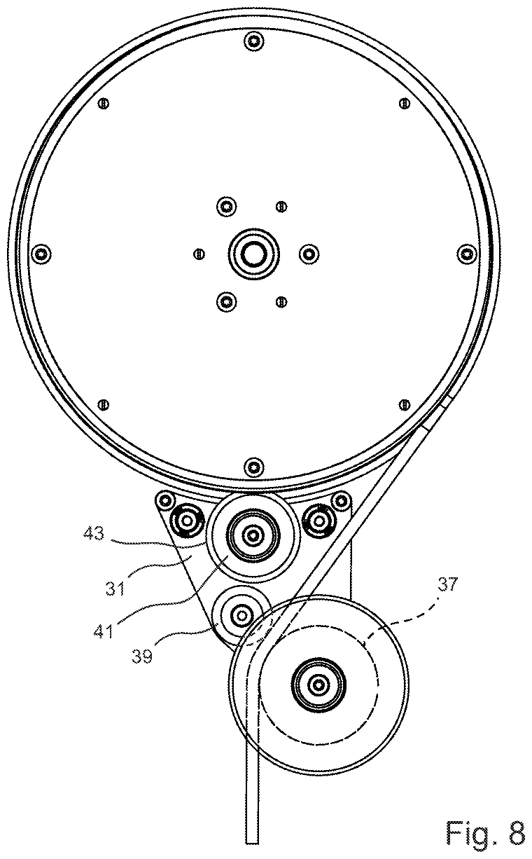

The interaction between the notch 35 and the collar of the hold-down roller 39, which engages in the notch 35, can be clearly seen in FIG. 8. It can be seen from the side view of FIG. 8 and FIG. 9 that the suspension means 11 is guided very effectively in the notch 35 of the guide roller 33 and the hold-down roller 39.

As can be seen clearly from FIGS. 6, 7, 8 and 9, a coupling roller 41 is arranged between the lateral walls 31 of the winding device in the immediate vicinity of the drum 7. The coupling roller 41 is arranged between the lateral walls 31 of the winding device 21 and is rotatably mounted. In this embodiment, the coupling roller 41 has two collars 43. The collars 43 are profiled in such a way that they engage in the groove 45 of the drum 9. This means that the winding device 21 is moved in the axial direction, i.e. to the right or to the left in FIG. 9, by rotating the drum 9. This axial movement is desmodromically coupled to the rotational movement of the drum 9 and depends on the pitch of the helical groove 45 in the drum 9. The winding device 21 is arranged in such a way that the suspension means 11 is held and guided in the guide roller 33 in such a way that it is guided directly into the groove 45 of the drum 9 when it is wound on. The suspension means 11 is wound on by a corresponding rotation of the drum. The unwinding of the suspension means 11 takes place in the same manner, only with a different/opposite rotational direction of the drum 9.

It can be clearly seen from FIG. 9 that the suspension means 11 is wound on in the groove 45 on the left-hand side of the drum 9. The right-hand half of the drum 9 is free. The guide roller 33, the hold-down roller 39 and the coupling roller 41 are arranged between the lateral walls 31 of the winding device 21 and are rotatably mounted.

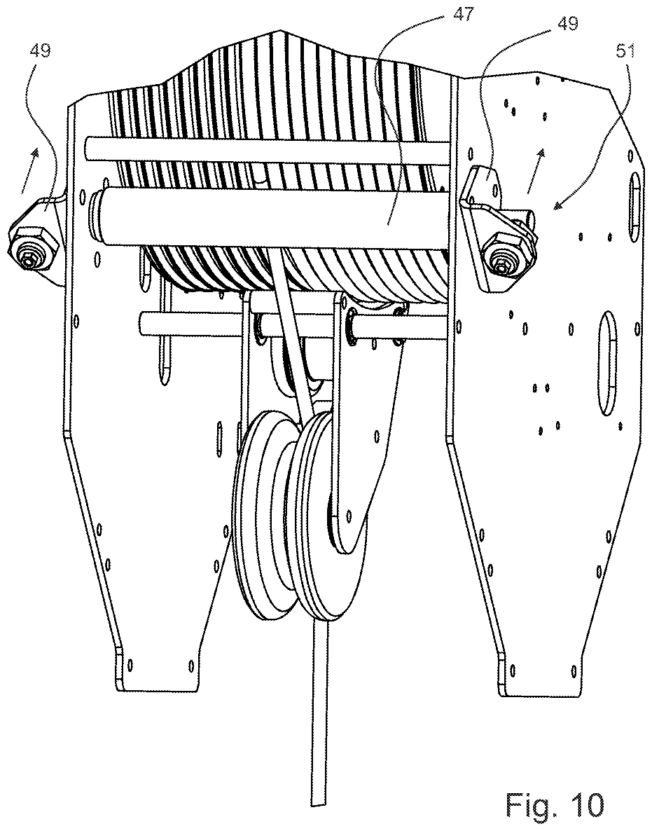

A portion of the winch 1 according to the invention is shown in FIG. 10. Said figure shows the lateral walls 5, the drum 9, the suspension means 11 and the winding device 21. In this embodiment, a rotatable pressing roller 47 is arranged between the lateral walls 5 and in parallel with the drum 9. Said pressing roller holds the suspension means 11 in the groove 45 of the drum 9.

In a simpler variant, the distance between the axes of rotation of the drum 9 and the pressing roller 47 is fixedly predetermined.

In the further improved variant shown in FIG. 10, the pressing roller 47 is pressed resiliently against the drum 9 or the suspension means 11 wound thereon.

For this purpose 5 brackets 49 are provided on the two lateral walls. The brackets 49 each have a bearing 51 for the pressing roller 47. The bearings 51, in turn, are resiliently attached to the brackets 49, such that they always press the pressing roller 47 against the drum 9 or the suspension means 11 wound thereon. The design details of the resilient mounting are not shown in FIG. 10; rather, two arrows show the direction in which the pressing roller 47 is pressed against the drum 9. These arrows are directed to the axis of rotation of the drum 9.

In both variants it is advantageous if the (cylindrical) contact surface of the pressing roller 47 consists of a flexible material. The pressing roller 47 is a further structural measure which prevents the suspension means 11 from jumping out of the groove 45.

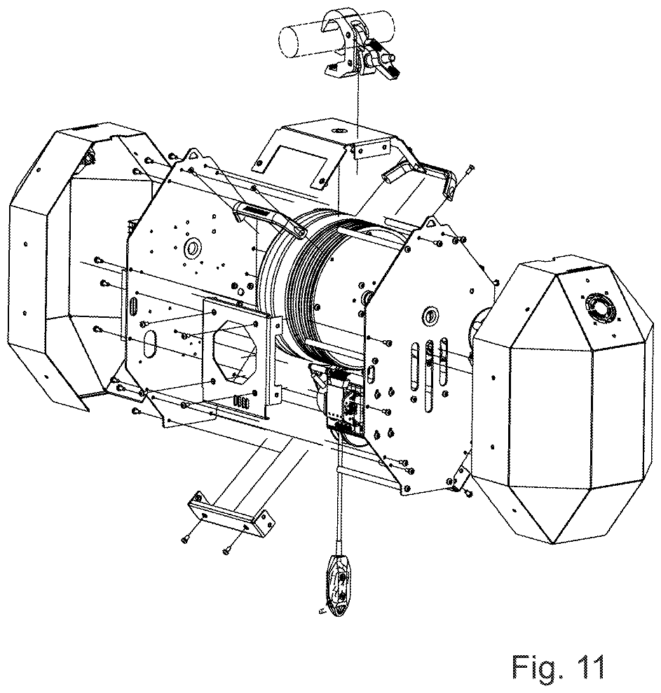

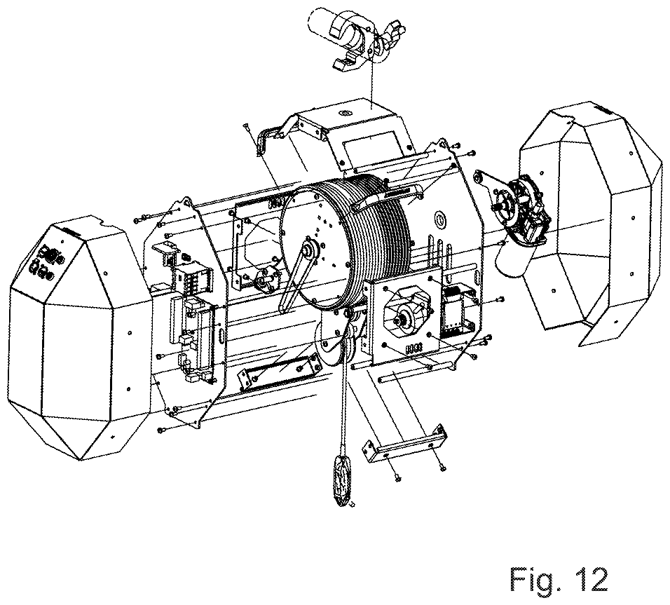

In FIGS. 11 and 12, the winch according to the invention is shown in two different exploded views (without reference signs) for the purpose of illustration. The device according to the invention is characterized by a very simple winding device which ensures a precise feeding of the suspension means into the groove 45 of the drum 9 under all circumstances. The winding device 21 according to the invention has a simple design, but is nevertheless very reliable and very quiet. It can be advantageous to produce the collars 43 of the coupling roller 41 from a plastics material in order to minimize the running noise. The same applies to the hold-down roller and the guide roller 33. The drum 9 can be provided with a covering made of a plastics material, into which the groove 45 is incorporated. The generation of disruptive operating noises is then also effectively prevented on the drum 45 side.

1. Winch comprising a drum, a suspension means, a winding device and a frame, the frame having a mounting for the drum and a linear guide for the winding device, the drum having a helical groove and the winding device having a coupling roller, and the coupling roller having at least one collar which engages in the helical groove of the drum, characterized in that the frame comprises two lateral walls, that the drum is rotatably mounted on the lateral walls, that a plurality of cross members are arranged between the lateral walls, that at least one of the cross members is designed as a linear guide for the winding device, that the winding device has two lateral walls, a plurality of spacers, and a guide roller for the suspension means, that the guide roller has a notch, that the hold-down roller engages in the notch of the guide roller, and in that spacer(s) are used as bearing pins for the coupling roller, the guide roller and/or a hold-down roller.

2-5. (canceled)

6. Winch according to claim 1, characterized in that a notch bottom of the notch is as wide as or wider than a diameter of the suspension means.

7-9. (canceled)

10. Winch according to claim 1, characterized in that the pitch of the helical groove is greater than or equal to a diameter of the suspension means.

11. Winch according to claim 1, characterized in that the coupling roller has two collars which engage in the helical groove of the drum, and in that an axial spacing (S) of the collars is equal to the pitch of the helical groove.

12. Winch according to claim 1, characterized in that the suspension means is an electrical cable, in particular comprising a tension strand, or a rope.

13. Winch according to claim 1, characterized in that it has a drive for the drum.

14. Winch according to claim 1, characterized in that it has at least one rotational angle sensor coupled to the drum.

15. Winch according to claim 1, characterized in that it has one or more limit switches.

16. Winch according to claim 1, characterized in that it has a pressing roller, that the axes of rotation of the pressing roller and the drum extend in parallel with one another, and in that a contact surface of the pressing roller is in contact with the drum and/or presses the suspension means wound on the drum into the groove of the drum.

17. Winch according to claim 16, characterized in that the pressing roller is resiliently mounted, and in that the resilient mounting presses the contact surface of the pressing roller against the drum and/or the suspension means wound on the drum.

18. Winch according to claim 1, characterized in that it has a control device for controlling the drive and for evaluating the signals transmitted by the rotational angle sensor(s) and/or the limit switch(es).
